(19) United States
(12) Patent Application Publication
(10) Pub. No.: US 2026/0117352 A1
(43) Pub. Date: Apr. 30, 2026

(54) Sintered-Metal Component

(71) Applicant: Siemens Aktiengesellschaft, München (DE)

(72) Inventor: Gotthard Rieger, München (DE)

(73) Assignee: Siemens Aktiengesellschaft, München (DE)

(21) Appl. No.: 18/850,450

(22) PCT Filed: Jan. 31, 2023
(86) PCT No.: PCT/EP2023/052291

§ 371 Date: Sep. 24, 2024

(30) Foreign Application Priority Data
Mar. 25, 2022 (EP) 22164331.5

(51) Int. Cl. C22C 38/44; B22F 1/062; H02K 1/02

(52) U.S. Cl. CPC C22C 38/44; B22F 1/062; H02K 1/02; B22F 2301/35; B22F 2999/00

(57) ABSTRACT

Various embodiments of the teachings herein include a sintered metal component. An example includes: a first magnetic material component comprising a ferromagnetic ferrous material; and a second load-bearing material component comprising an iron-chromium alloy. The first component and the second component are mutually separated and mutually adjoining. The second load-bearing material component has a microstructure has an austenitic phase of between 20% by volume and 40% by volume and a ferritic phase of between 60% by volume and 80% by volume.

### CROSS-REFERENCE TO RELATED APPLICATIONS

This application is a U.S. National Stage Application of International Application No. PCT/EP2023/052291 filed Jan. 31, 2023, which designates the United States of America, and claims priority to EP Application No. 22164331.5 filed Mar. 25, 2022, the contents of which are hereby incorporated by reference in their entirety.

### TECHNICAL FIELD

The present disclosure relates to manufacturing. Various embodiments of the teachings herein include a sintered metal component.

### BACKGROUND

In electric machines in particular, there are components, for example rotors, on which high demands are placed with regard to mechanical properties, especially strength with simultaneously high magnetic moment. Pure ferritic steels that may be advantageous for magnetic reasons, for example pure iron, meet strength demands in the case of high-performance motors only to an inadequate degree.

In conventional electric machines, for example generators or electric motors, especially motors excited by asynchronous, reluctant and permanent magnets, ferritic iron-silicon laminations are used, which constitute a compromise between reduced magnetic moment, good loss properties via elevated electrical resistance, and elevated strength.

In the case of magnetic laminations that are combined to form a magnetic laminated core and hence form an essential component of the rotor, hybrid and in particular co-sintered components are also used. Thus, different materials are used, which either tend to satisfy magnetic properties or satisfy mechanical properties. In this context, either high stress states resulting from unmatched thermal expansion are accepted or, for the nonmagnetic portion, material systems are employed that either have a high ferrite content in the form of rounded a-iron crystals and therefore lead to scatter fields and therefore losses of magnetic flux in the nonmagnetic component, or nickel-based alloys are employed that have highly varying sintering properties and are uneconomical owing to the cost structure. A further means of matching the coefficients of thermal expansion in different material systems in a component is to introduce transition layers, but this considerably increases manufacturing complexity and adversely affects the planarity of the electrical laminations.

### SUMMARY

The electrical laminations described for electric machines are merely one example to describe the problems associated with the demand for high strengths on the one hand and high magnetic properties on the other hand in one component. The teachings of the present disclosure include components that have locally very good magnetic, in particular soft-magnetic, properties and which provides very high mechanical durability. For example, some embodiments include a sintered metal component comprising two functional, mutually separated, mutually adjoining material components (4, 6), where a magnetic material component (4) comprises a ferromagnetic ferrous material and a load-bearing material component (6) comprising an iron-chromium alloy, characterized in that the load-bearing material component has a microstructure (8) having an austenitic phase (10) and a ferritic phase (12), where the proportions by volume of the ferritic phase (12) in the microstructure (8) are between 60% by volume and 80% by volume, and the proportions by volume of the austenitic phase (10) are between 20% by volume and 40% by volume.

In some embodiments, the magnetic material component (4) has an iron content higher than 95% by weight, in particular higher than 98% by weight.

In some embodiments, ferritic phase components (12) of the microstructure (8) of the load-bearing material component (6) have a whisker-shaped form with an aspect ratio greater than 5.

In some embodiments, 70% of the whisker-shaped ferritic phase constituents (12) have a longitudinal extent between 100 μm and 300 μm.

In some embodiments, the iron-chromium alloy of the load-bearing material component (10) has a chromium content between 22% by weight and 28% by weight, in particular between 24% by weight and 26% by weight.

In some embodiments, the iron-chromium alloy of the load-bearing material component (8) has a nickel content between 4% by weight and 10% by weight, in particular between 6% by weight and 8% by weight.

In some embodiments, the iron-chromium alloy of the load-bearing material component has a molybdenum content between 2% by weight and 5% by weight, in particular between 3% by weight and 4% by weight.

In some embodiments, the iron-chromium alloy of the mechanically load-bearing material component has a tungsten content between 0.3% by weight and 1.2% by weight, in particular between 0.5% by weight and 1% by weight.

In some embodiments, the austenitic phase (10) incorporates ceramic particles (14) and the proportion by volume of the particles (14) is between 5% and 20% by volume.

In some embodiments, the ceramic particles (14) comprise YSZ, TiC or Sic.

In some embodiments, the component (2) is a two-dimensional component (2).

In some embodiments, the component (2) is a screen-printed and/or template-printed component (2).

In some embodiments, the component (2) is a magnetic lamination (16) for a laminated core (18) of a rotor (20) of an electric machine (22) and has a bore (24) for a shaft (26).

In some embodiments, the magnetic material component (4) has a curved progression (28) which is the opposite of a circle around the center (32) of the bore (24).

In some embodiments, four regions with the magnetic material component (4) are provided.

### BRIEF DESCRIPTION OF THE DRAWINGS

Further configuration forms and further features are elucidated in detail by the description of figures that follows. These are purely schematic configuration forms that do not constitute any restriction of the scope of protection. In principle, the sintered metal components described are appropriately usable wherever mechanical and magnetic properties are required in particular local regions of a component. This is not intended to impose any restriction to magnetic laminations for electric machines. In the figures:

FIG. 1 an exploded diagram of an electric machine comprising an electric motor with rotor and shaft;

FIG. 2 a schematic diagram of a conventional laminated core with a multitude of magnetic laminations according to the prior art, as used in conventional electric motors;

FIG. 3 a sintered metal component in a schematic diagram with a magnetic component and a load-bearing component;

FIG. 4 a first example of a microstructure of the alloy of the load-bearing component;

FIG. 5 a further example of a microstructure of an alloy of the load-bearing component with austenitic and ferritic fractions;

FIG. 6 a graph 4 the coefficient of thermal expansion of various materials as a function of temperature; and

FIG. 7 a graph of the coefficient of thermal expansion as a function of a proportion by volume of ceramic particles in the austenitic phase.

### DETAILED DESCRIPTION

Some embodiments of the teachings here include a sintered metal component comprising two functional, mutually separate, mutually adjoining material components. The first of these is a magnetic material component comprising a ferromagnetic ferrous material. The second is a load-bearing material component designed for mechanical strength in particular, where this load-bearing material component comprises an iron-chromium alloy. This load-bearing material component has a microstructure comprising an austenitic phase and a ferritic phase. In practice, this condition covers, for example, the steels known as duplex steels. In addition, the microstructure of the load-bearing material component also has the feature that proportions by volume of the ferritic phase in the microstructure are between 60% by volume and 80% by volume. The proportions by volume of the austenitic phase in the microstructure, by contrast, are between 20% by volume and 40% by volume.

Materials having a very high iron content and having particularly good soft-magnetic properties that are required for use in a component for electric machines have a coefficient of expansion which is generally between 10×10⁻⁶1/K and 15×10⁻⁶ 1/K. The mechanical components described, i.e. steels having both a ferritic phase and an austenitic phase in the proportions described, may be established with a virtually identical coefficient of expansion by appropriate selection within the ranges described. The ferritic phase is predominant in the described microstructure of the load-bearing material component, but ferritic precipitates in the austenitic matrix component are blocked owing to the austenitic phase in such a way that no transmagnetization of the ferritic phase components can arise, which means that the flux regime of the magnetically shaped material fraction of the component is not adversely affected.

The two material components used, both the magnetic material component and the load-bearing material component, are based on iron, and their shrinkage characteristics can be matched by simple measures such as the addition of sintering aids, and they can therefore be produced in a single sintering process, such that the desired microstructure of the load-bearing component is formed. Firstly, by the sintering process and secondly by selection of the material components described, it is thus possible to produce a component that both withstands very high mechanical stresses and has very good soft-magnetic properties in the desired regions, which is especially also brought about via adaptation of the coefficients of expansion which is possible by virtue of the material components described.

In relation to microstructure formers and phase components in a particular inner phase microstructure, the unit & by volume is used; in the case of alloy components that are yet to be described, percentages by weight are used. This distinction is customary in the art and makes sense for the alloys in particular in that one mass is indeed being compared here with another mass of the alloy. In the case of microstructure formers in which different elements are involved in particular phases, the statement of percentages by weight would be inappropriate since these can constantly vary and would be too inaccurate, and therefore percentages by volume are used for these figures.

Hereinafter, for analysis of the phase components, a planar section through the material is made and evaluated with a reflected light microscope using image processing software. For the image processing, it is possible to use, for example, both a Zeiss microscope and the associated ZEN software.

In some embodiments, the magnetic material component has an iron content higher than 95% by weight, especially as high as 98% by weight. Typically, one of the remaining alloy elements is silicon, but it should be emphasized that pure iron, optionally alloyed with cobalt up to 50% by weight, has appropriate soft-magnetic properties.

In some embodiments, the ferritic phase component of the microstructure of the load-bearing material component has a whisker-shaped form with an aspect ratio of greater than 5. What is meant by whisker-shaped is that elongated precipitates having the cubic body-centered ferrite structure are formed in a very substantially homogeneous matrix formed by the austenitic phase constituent. These are present mainly in a length between 100 μm and 300 μm. This length fraction of the whisker-shaped ferritic precipitates is preferably about 70% by volume. This means that 70% of the ferritic whisker-shaped structure constituents are in the length of 100 μm and 300 μm. Such microstructure characteristics are also detailed with reference to the described image analysis of a section.

In some embodiments, the iron-chromium alloy of the load-bearing material component has a chromium content between 22% by weight and 28% by weight, especially between 24% by weight and 26% by weight. Chromium is a ferrite former, which, in the case of appropriate cooling from the sintering process, promotes the formation of ferrite crystals. In addition, the alloy has a nickel content of between 4% by weight and 10% by weight, especially between 6% by weight and 8% by weight. Nickel, by contrast, is what is called an austenite former, which promotes austenitic phase constituents on cooling. Both phase constituents, austenite and ferrite, as already set out, are important constituents in the equilibrium of the load-bearing material component since the ratios described prevent both original mechanical strengths and soft-magnetic characteristics. Such chromium-nickel steels, also known as duplex steels, as well as high tensile strength, also have comparatively high ductility, and they are therefore of particularly good suitability as load-bearing component for the sintered metal component described.

In some embodiments, the iron-chromium alloy also comprises molybdenum in proportions between 2% by weight and 5% by weight, especially between 3% by weight and 4% by weight. The proportion of tungsten may be between 0.3% by weight and 1.2% by weight, especially between 0.5% by weight and 1% by weight. The two latter alloy constituents, molybdenum and tungsten, contribute firstly to higher strength of the alloy; secondly, they are suitable for establishing the desired coefficient of expansion in particular, which is close to that of the magnetic component.

A further measure for influencing the fine adjustment of the coefficient of expansion is the incorporation of particles, especially ceramic particles, in the austenitic phase. These incorporated particles have a proportion by volume of between 5% and 20% by volume. Ceramic particles that have been found to be useful are in particular silicon carbide, yttrium-stabilized zirconia, TiC and SiC particles.

In some embodiments, the sintered metal component described is a two-dimensional component. The material components described, the magnetic component and the load-bearing component, generally adjoin one another such that they abut one another at their blunt end faces. Specifically at these interfaces, it is important that the coefficient of expansion between the two material components has minimum differences in order that only very low mechanical stresses, if any, by virtue of different coefficients of expansion occur in these comparatively small end faces and small transition zones. This is true in particular in the production, in the joint cooling after the sintering process and also in relation to sustained strength in operation.

Such a two-dimensional component is producible particularly efficiently via a screenprinting process and/or template printing process. The term “screenprinting” is covered here by the umbrella term “template printing”, where a paste comprising the functional constituent of the components is pressed by means of a squeegee through a screen or through an open template and printed onto the surface. Such printed three-dimensional structures, which typically have a thickness of 80 to 300 μm, can subsequently be consolidated in a sintering method to give the sintered metal component.

In some embodiments, the sintered metal component described is a magnetic lamination for a laminated core of a rotor of an electric machine. At the same time, it has a bore for a shaft. Especially in laminated cores of rotors of electric machines, i.e. generators and electric motors, high mechanical stresses are generated, with a simultaneous need for very good magnetic properties at least locally in the laminated core or the magnetic lamination.

In some embodiments, the magnetic material component has a curved profile. In the specific case of the rotor of a reluctance motor, this curved profile is the opposite of a circle around the center of the bore in the magnetic lamination or the component. Such a curved, self-contained region of the magnetic material component permits a very good flux regime to form the magnetic poles.

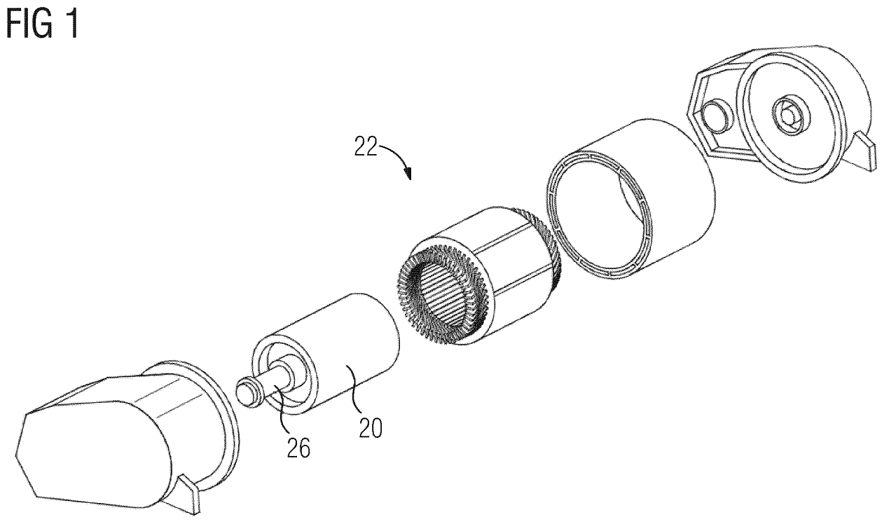

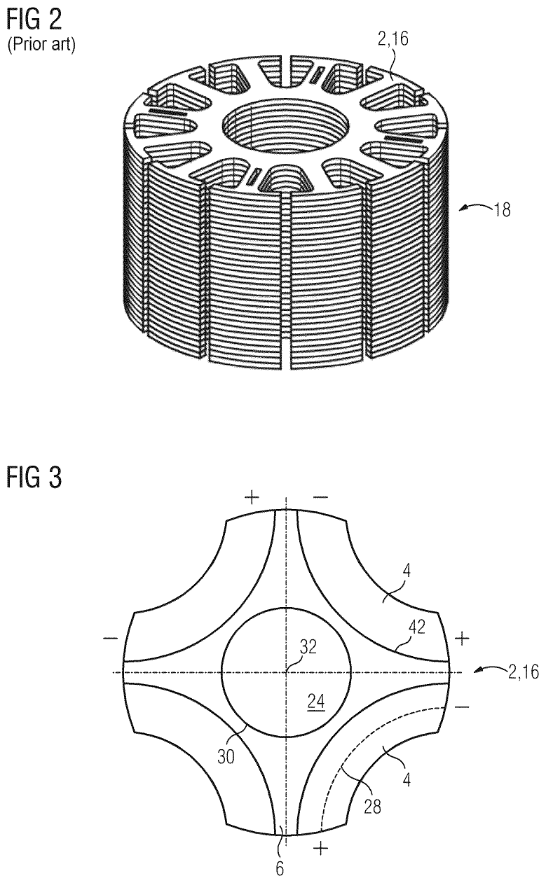

FIG. 1 shows an exploded diagram of an electric machine 22 comprising an electric motor. The individual constituents represented visually here will not be addressed in detail at this point. These are, by way of example, customary components of an electric machine 22. Emphasis shall be given to a rotor 20 and a shaft 26 on which the rotor 20 is mounted and which is the driveshaft for the electric machine 22. This diagram is very simplified and is therefore, for classification of the further description in FIG. 2, a customary laminated core 18 according to the prior art. Laminated cores 18 with a multitude of magnetic laminations 16 may be configured in this way. According to the prior art, the magnetic laminations 16 are typically configured in the form of punched sheet metal; in the context of this description, the magnetic laminations 16 are configured in the form of sintered metal components 2.

FIG. 3 shows an example sintered metal component 2 in the form of a magnetic lamination 16. This magnetic lamination 16 has both a magnetic material component 4 and a load-bearing material component 6. The load-bearing material component 6 is disposed in the center of the magnetic lamination 16. It has a bore 24, through which, in an operation-ready state, the shaft 26 (not shown here; cf. FIG. 1) can be fed. The magnetic material components 4 have a curved profile 28, where the curvature 28 is the opposite of a circle 30 around a center 32 of the bore 24. Such a curvature 28 of the magnetic material component 4 assures a very good magnetic flux regime to form magnetic poles (indicated by + and − in FIG. 3). Overall, the example of the magnetic lamination 16 in FIG. 3 has four such magnetic material components 4. The diagram according to FIG. 3 is a merely illustrative configuration form of a sintered metal component 2 in the form of the magnetic lamination 16.

What is characteristic about the sintered metal component 2 Is that two material components 4, 6 with fundamentally different material properties abut one another at an abutment edge 42 in a component 2 which is two-dimensional here. The interface of the abutment edge 42, which is not shown here, constitutes the transition between two different materials that generally have two different coefficients of thermal expansion. In operation of the rotor 20, especially in the case of high-power machines, high centrifugal forces are introduced, and these lead to considerable heating of the rotor 20, especially also of the laminated core 18.

This means that the component 2 expands thermally as part of a laminated core 18, resulting in stresses at the abutment edge 42 between the two material components 4 and 6 by virtue of different coefficients of thermal expansion.

The reason why two different material components are used is that purely soft-magnetic materials such as iron do not have high strength such that they withstand the stresses on rotation of a high-power motor. This purpose is served by the load-bearing material component 6. It is additionally appropriate in respect of the load-bearing material component 6 when it has a minimum level of soft-magnetic properties, or none at all, such that magnetic flux can flow along the curved line 28 optimally between the two plus and minus poles. This avoids or at least significantly reduces eddy current losses within the magnetic lamination 16 or laminated core 18.

In principle, however, it has not been possible to date to find materials where one material component has sufficiently high mechanical durability and the other material component has very good soft-magnetic properties. This should now be ensured in that the magnetic material component 4 has a maximum iron content; an iron content of more than 95% may be advantageous; in particular, this may also include cobalt, or silicon for stabilization. The magnetic material component 4 is formed therefrom. The load-bearing material component 6 in turn is formed by an iron-chromium alloy having a characteristic microstructure 8 which firstly comprises an austenitic phase 10 and secondly a ferritic phase 12.

It has been found that such a microstructure in which the proportion by volume of the ferritic phase 12 in the microstructure 8 is between 60% by volume and 80% by volume can cause a coefficient of expansion very close to that of the ferromagnetic iron material.

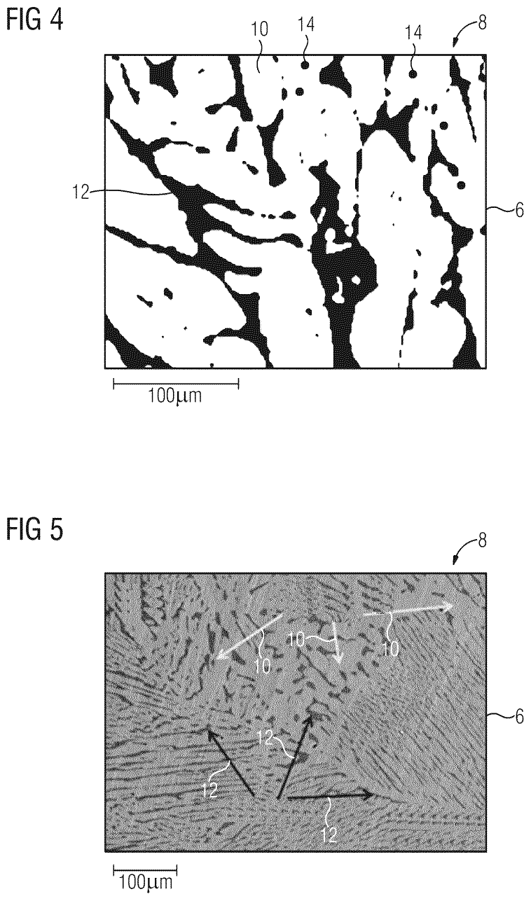

FIGS. 4 and 5 show typical microstructure formers of a planar section of the material of the load-bearing material component 6. The typical progression of the austenitic phase 10 and of the ferritic phase 12 is apparent. The austenitic phase 10 can be seen, if anything, as a matrix in which ferritic phase components 12 are formed. The ferritic phase components 12 are in whisker-shaped configuration, meaning that they have an elongated structure, where the majority of these ferritic structure constituents 12 have a length between 100 and 300 μm. Because of their elongated form, the aspect ratio thereof is greater than 5. It is also possible here for dendritic structures to arise, each of which on their own may also again have a whisker-shaped elongated extent with the aspect ratio described.

The microstructure described, in FIGS. 4 and 5, has the unusual feature that the austenitic microstructure 10 incorporates the ferritic phase constituents 12 such that, in the event of transmagnetization, i.e. a reversal of polarity during the operation of the motor, they do not cause any change in their domains, and so they have only very minor soft-magnetic properties, if any. This means that the entire region of the load-bearing material component 6 does not have any significant soft-magnetic properties, and hence does not undergo any disruption of magnetic flux either, as desired in the magnetic material component 4. The load-bearing material component 6 is thus at least largely magnetically inactive and merely constitutes the load-bearing structures of the component 2.

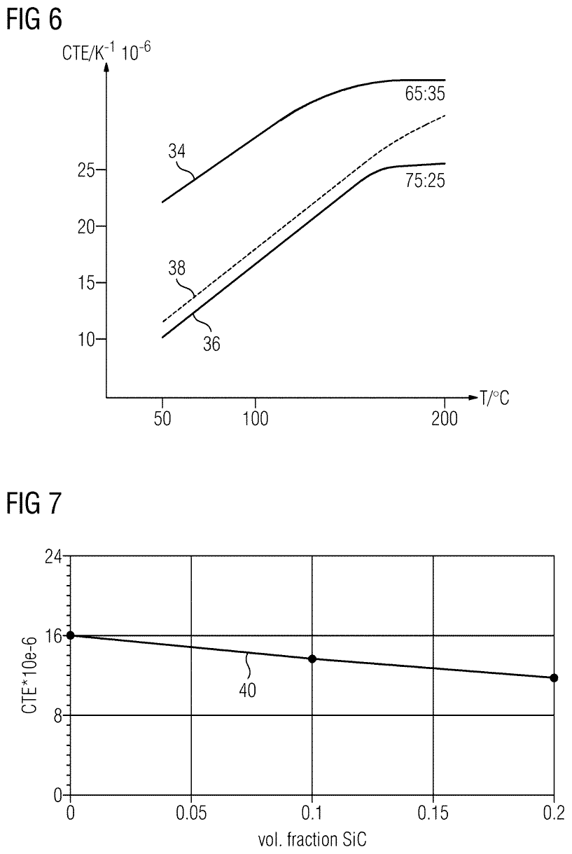

FIG. 6 shows a diagram showing temperature on its X axis and the coefficient of thermal expansion CTE in the unit 10⁻⁶ K⁻¹ on its Y axis. Two different iron-chromium alloys of the load-bearing material component 6 are shown here. These are given the reference numerals 34 and 36. The first alloy is an iron-chromium alloy having 25% by weight of chromium, having 7% by weight of nickel, and additionally alloyed with molybdenum and tungsten. What is interesting about this alloy, aside from the composition, is also the ratio between the ferritic phase 12 and the austenitic phase 10. In the first curve 34, the ferritic phase 12 is present at 65% by volume; the austenitic phase has 35% of the volume of the microstructure. In the second curve of a second load-bearing material component 36, the ferritic phase component is 75% by volume, the austenitic phase component 25% by volume. Additionally plotted by way of example as a dotted line is a corresponding curve 38 of a magnetic material component 4. It should be noted here that, although these curves 34, 36 and 38 are given values in the diagram, they are nevertheless qualitative curves that are merely intended to roughly illustrate the progression and possible matching of coefficients of thermal expansion in the materials described.

It can be seen at this point from FIG. 6 that the progression of the magnetic material component 38 with regard to temperature and the internal coefficient of thermal expansion established lies very close to the curve 36 of the load-bearing material component 6, which has a ferritic component of 75% compared to an austenitic phase component of 25%. Depending on which material is used for the magnetic material component 4 or the load-bearing material component 6, the steels described may be matched correspondingly to the load-bearing material component, such that the corresponding curves for the coefficient of thermal expansion as a function of temperature are as far as possible from one another, such that there is a minimum mismatch between the coefficients of thermal expansion at the described abutment edge 42 between the two material components 4 and 6.

It should be noted here that the described microstructure 8 of the load-bearing material component 6 depends not only on the composition of the alloy per se but also on the production process, in the form of a sintering process. This will be addressed further hereinafter. It should also be noted that a fine adjustment between the coefficients of thermal expansion of the magnetic material component 4 and the load-bearing material component 6 can still be optimized within a certain range in that fine particles are introduced to a small degree into the austenitic phase 10 of the microstructure 8.

This Is illustrated in FIG. 7. The curve 40 therein shows the change in the coefficient of thermal expansion of the load-bearing material component 6 as a function of the addition of YSZ, Tic or SiC particles embedded in the austenitic phase 10 of the microstructure 8. Addition of very small amounts down to 0.2% by volume can have the effect that the coefficient of thermal expansion drops from 16×10⁻⁶ K⁻¹ to 11×10⁻⁶ K⁻¹. The addition of these small amounts of particles, for example titanium carbide, yttrium-stabilized zirconia or silicon carbide, allows the coefficient of thermal expansion to finally be matched between the two material components 4 and 6 so as to minimize thermal stresses that occur at the abutment edge 42.

A possible mode of production of the sintered metal component 8 is to be addressed hereinafter, which arises in particular for the production of magnetic laminations 16 in combination of the two functional, mutually separate but mutually adjoining, material components 4 and 6. For this purpose, in particular, a screen printing method or template printing method is employed.

For this purpose, two characteristic printing pastes (not detailed here) are produced that include, in addition to the base material of the two components, the magnetic material component 4 and the load-bearing material component 6, corresponding inorganic or organic binders that assure printability of the paste. These pastes are printed onto a flat surface successively by means of a template, optionally assisted by a screen. The printed material has a thickness between 100 μm and 300 μm, e.g. 200 μm. In this printed precursor, the material components 4 and 6 described in FIG. 3 have already been printed on separately in the form shown therein. The abutment edge 42 already exists here as a precursor after the printing operation. This precursor that has thus been printed is then detached from its substrate and subjected to thermal treatment in a sintering furnace.

Sintering is a thermal process in which material grains react with one another in their interface region via diffusion processes, and occasionally also via melting processes, with formation of sinter necks and establishment of solidification of the material, in particular low-porosity material character. However, this is not a melting process in which the material melts homogeneously and solidifies again. By virtue of this sintering process, a relatively long cooling phase, for example in the range between 2 and 9 hours in the sintering furnace described, creates the desired microstructure 8, which comprises precisely that proportion between austenitic phase 10 and ferritic phase 12. It is possible here to produce both the magnetic material component 4 and the load-bearing material component 6 during a common heat treatment process or sintering process. After the sintering process, the magnetic lamination 16 thus sintered is removed and stacked to give a magnetic laminated core 18 that can serve as rotor 20 of the electric machine 22.

### LIST OF REFERENCE NUMERALS

2 sintered metal component
4 magnetic material component
6 load-bearing material component
8 microstructure of iron-chromium alloy
10 austenitic phase
12 ferritic phase
14 ceramic particles
16 magnetic lamination
18 laminated core
20 rotor
22 electric machine
24 bore
26 shaft
28 curved progression
30 circle
32 center of bore
34 first load-bearing material component
36 second load-bearing material component
38 third load-bearing material component
40 proportion by volume of particles
42 abutment edge

What is claimed is:

1. A sintered metal component comprising:
a first magnetic material component comprising a ferromagnetic ferrous material; and
a second load-bearing material component comprising an iron-chromium alloy;
wherein the first component and the second component are mutually separated and mutually adjoining;
the second load-bearing material component has a microstructure an austenitic phase of between 20% by volume and 40% by volume and a ferritic phase of between 60% by volume and 80% by volume.

2. The sintered metal component as claimed in claim 1, wherein the first magnetic material component includes an iron content higher than 95% by weight.

3. The sintered metal component as claimed in claim 1, wherein the ferritic phase components of the second load-bearing material component have a whisker-shaped form with an aspect ratio greater than 5.

4. The sintered metal component as claimed in claim 3, wherein 70% of the whisker-shaped ferritic phase constituents have a longitudinal extent between 100 μm and 300 μm.

5. The sintered metal component as claimed in claim 1, wherein the iron-chromium alloy of the second load-bearing material component has a chromium content between 22% by weight and 28% by weight.

6. The sintered metal component as claimed in claim 5, wherein the iron-chromium alloy of the second load-bearing material component has a nickel content between 4% by weight and 10% by weight.

7. The sintered metal component as claimed in claim 5, wherein the iron-chromium alloy of the second load-bearing material component has a molybdenum content between 2% by weight and 5% by weight.

8. The sintered metal component as claimed in claim 5, wherein the iron-chromium alloy of the second load-bearing material component has a tungsten content between 0.3% by weight and 1.2% by weight.

9. The sintered metal component as claimed in claim 1, wherein the austenitic phase incorporates ceramic particles and the proportion of between 5% and 20% by volume.

10. The sintered metal component as claimed in claim 9, wherein the ceramic particles comprise YSZ, TiC, and/or Sic.

11. The sintered metal component as claimed in claim 1, wherein the component comprises a two-dimensional component.

12. The sintered metal component as claimed in claim 1, wherein the component comprises a screen-printed and/or template-printed component.

13. The sintered metal component as claimed in claim 1, wherein the component comprises a magnetic lamination for a laminated core of a rotor of an electric machine and has a bore for a shaft.

14. The sintered metal component as claimed in claim 13, wherein the first magnetic material component has a curved progression opposite a circle around the center of the bore.

15. The sintered metal component as claimed in claim 13, comprising four regions with the first magnetic material component.
